(19) United States
(12) Patent Application Publication
(10) Pub. No.: US 2007/0279841 A1
(43) Pub. Date: Dec. 6, 2007

(54) Chip capacitor

(75) Inventors: Jae Kwang Kim, Suwon (KR); Hee Dong Myung, Suwon (KR); Jae Jun Park, Hwasung (KR); Gyu Hwang Lee, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/806,560

(22) Filed: Jun. 1, 2007

(30) Foreign Application Priority Data
Jun. 2, 2006 (KR) 10-2006-0049779

(51) Int. Cl. H01G 9/00; H01G 4/228

(52) U.S. Cl. 361/540

(57) ABSTRACT

A chip capacitor which can be miniaturized with structural stability. In the chip capacitor, a capacitor device has a cathode layer formed on an outer surface thereof and an anode wire is protruded from a portion thereof. A cathode lead is electrically connected to the cathode layer. An anode lead is electrically connected to the anode wire through a weld reinforcement. A molding is configured to cover the capacitor device in such a way that the cathode and anode leads are only partially exposed. Protrusions are protruded from outer surfaces of the cathode and anode leads, respectively, thereby forming steps on the outer surfaces thereof. In the chip capacitor, the leads and molding are bonded with much greater strength, thus more structurally robust. Also, this prevents external moisture from penetrating inside the chip capacitor, thereby significantly enhancing moisture resistance.

### CLAIM OF PRIORITY

This application claims the benefit of Korean Patent Application No. 2006-49779 filed on Jun. 2, 2006 in the Korean Intellectual Property Office, the disclosure of which is incorporated herein by reference.

### BACKGROUND OF THE INVENTION

1. Field of the Invention

The present invention relates to a chip capacitor miniaturizable with structural stability, more particularly, in which steps are formed on outer surfaces of anode and cathode leads, respectively, to bond a molding and the leads together with greater strength, and external moisture is minimally penetrated thereinto to assure stable electrical capability.

2. Description of the Related Art

In general, a tantalum capacitor, i.e., a solid chip capacitor is widely used in general industrial devices and application circuits requiring a low range of rated voltage. Especially, the solid chip capacitor is broadly utilized in circuits with poor frequency characteristics. Also, the solid chip capacitor is greatly employed to reduce noises of a mobile telecommunication device.

As shown in FIG. 1, a conventional chip capacitor 100 includes a capacitor device 104, a tantalium lead wire 106, an anode lead 110 and a cathode lead 110. The capacitor device 104 is installed inside a molding 102. The tantalium lead wire 106 is formed integral with the capacitor device 104 and protruded from a portion thereof 104 and 06. The anode lead 110 is electrically connected to the tantalium lead wire 106 by a weld reinforcement 108 and partially protruded out of the molding 102. The cathode lead 114 is formed opposite to the anode lead 110 and in contact with the capacitor device 104.

Moreover, in this conventional chip capacitor 100, the anode lead 110 and cathode lead 114 are mounted on a printed circuit board (PCB) 130 by soldering.

Meanwhile, to fabricate the capacitor device 104 of the chip capacitor 100, a dielectric powder is formed into a parallelepiped shape and sintered through pressing. Then a dielectric film is formed on an outer surface of the dielectric powder through chemical conversion. Next, the resultant dielectric film is impregnated in a manganese nitrate solution to form a manganese dioxide layer made of a solid electrolyte on an outer surface thereof.

The conventional chip capacitor 100 as described above has lately been in wide use in a compact device, thus gradually decreased in its size. A smaller size in the chip capacitor 100 also downscales the size of the anode and cathode leads 110 and 114. This, however, causes the anode and cathode leads 110 and 114 and the capacitor device 104 to be bonded together with less strength.

That is, the anode and cathode leads 110 and 114 should be fixedly joined to the tantalium lead wire 106 by the molding 102, accordingly posing no problem to the electronic devices.

However, the anode and cathode leads 110 and 114 according to the prior art are merely inserted in the molding 102. Therefore, external impact, if imposed, may detach the anode and cathode leads 110 and 114 from the capacitor device 104 or the tantalium lead wire 106.

Moreover, when the cathode lead 114 is electrically connected to the capacitor device 104 through an Ag paste 124, the Ag paste 124 is decreased in its bonding area, thereby hampering stable electrical connection.

FIG. 2 illustrates another example of a conventional chip capacitor 200, which is disclosed in U.S. Pat. No. 6,262,878.

In the chip capacitor of FIG. 2, a capacitor device 202 has a cathode layer 204 formed on an outer surface thereof and a tantalium lead wire 206 protruded from a portion thereof. Also, a planar cathode lead 210 is formed on a portion of an underside surface in parallel with the cathode layer 204 to be electrically connected thereto. Meanwhile, a planar anode lead 220 is formed on another portion of the underside surface to be electrically connected to an anode connecting member 214.

In addition, a molding 240 is formed to surround the capacitor device 202, the tantalium lead wire 206, the cathode lead 210 and the anode lead 220.

In the chip capacitor 200 configured as above, to enhance a volume ratio of the capacitor device 202, the anode and cathode leads 210 and 220 are located on the underside surface of the cathode layer 204. Also, the anode and cathode leads 210 and 220 are electrically connected, to a PCB substrate 230 by soldering 232. Yet, in this conventional structure, the anode and cathode leads 210 and 220 are not firmly joined to the molding 240.

Especially, in the conventional chip capacitor 200, the anode and cathode leads 210 and 220 formed on the underside surface of the cathode layer 204 are attached onto the PCB substrate 230 by the soldering 232. This soldering 232 is applied on side portions of the anode and cathode leads 210 and 220, which are thus electrically connected to the PCB substrate 230 unstably.

Furthermore, the conventional chip capacitors 100 and 200 have the anode and cathode leads 110 and 114; 210 and 220 just inserted in the molding 102 and 240. Accordingly, external moisture penetrates into the capacitor device 104 and 202 through the anode and cathode leads 110 and 114; 210 and 220 in the molding 102 and 240, thereby potentially causing malfunction to electrical performance thereof.

### SUMMARY OF THE INVENTION

The present invention has been made to solve the foregoing problems of the prior art and therefore an aspect of the present invention is to provide a chip capacitor in which anode and cathode leads are bonded together with greater strength to a molding to ensure structural stability as well as minimize infiltration of external moisture to greatly improve moisture resistant characteristics.

Another aspect of the invention is to provide a compact, slim and highly reliable chip capacitor which is structurally robust and electrically stable when mounted on a printed circuit board (PCB).

According to an aspect of the invention, the chip capacitor includes a capacitor device having a cathode layer formed on an outer surface thereof and an anode wire protruding from a portion thereof; a cathode lead electrically connected to the cathode layer; an anode lead electrically connected to the anode wire through a weld reinforcement; a molding configured to cover the capacitor device in such a way that the cathode and anode leads are only partially exposed; and protrusions protruding from outer surfaces of the cathode and anode leads, respectively, thereby forming steps on the outer surfaces thereof, whereby the chip capacitor is enabled to have a miniaturized structure with structural stability.

Preferably, the steps of the protrusions are extended along length and width directions of the cathode lead.

Preferably, the steps of the protrusions are extended along length and width directions of the anode lead.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view illustrating a conventional chip capacitor, in which (a) is a side cross-sectional view and (b) is a cross-sectional view cut along the line A-A′;

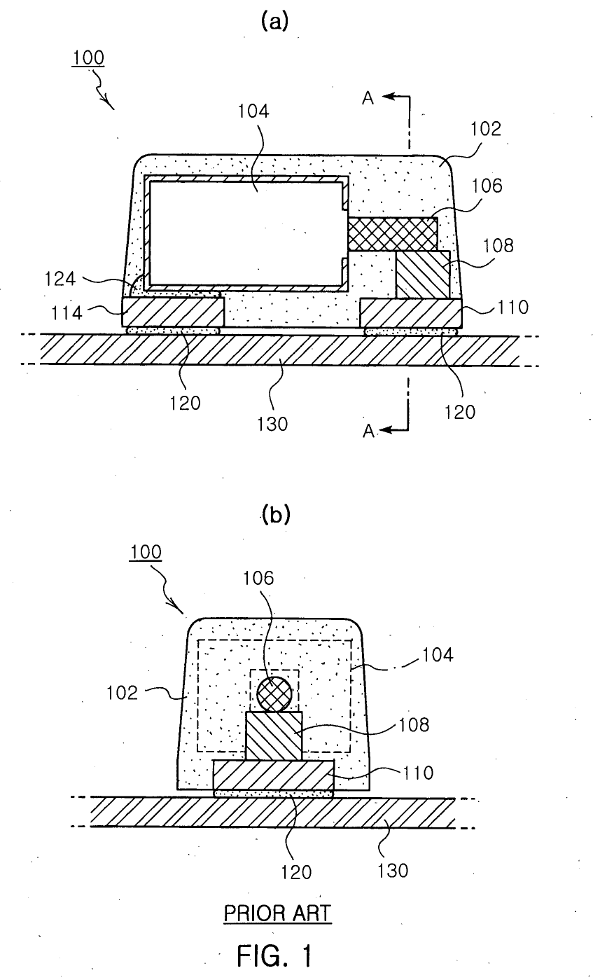

FIG. 2 is a side cross-sectional view illustrating another example of a conventional chip capacitor;

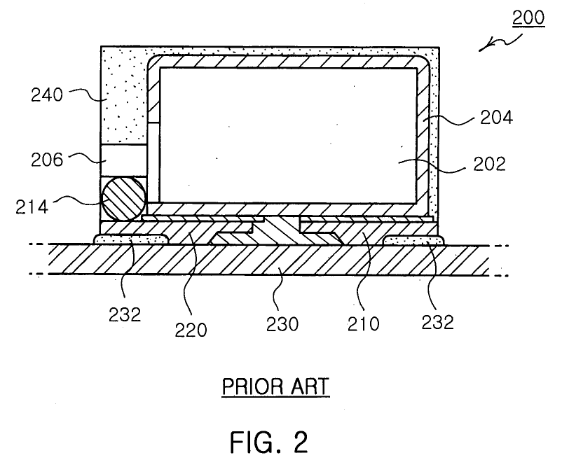

FIG. 3 is a side cross-sectional view illustrating a chip capacitor according to the invention;

FIG. 4 is a cross-sectional view cut along the line B-B′ of FIG. 3;

FIG. 5 illustrates a conventional chip capacitor structure together with a chip capacitor structure of the invention to show that the chip capacitor of the invention is superior in bonding strength to the conventional structure, in which (a) illustrates the conventional structure and (b) illustrates the structure according to the invention;

FIG. 6 illustrates a conventional chip capacitor structure together with a chip capacitor structure of the invention to show that the chip capacitor of the invention is superior in moisture resistance to the conventional structure, in which (a) illustrates the conventional structure and (b) illustrates the structure according to the invention; and

FIG. 7 is a cross-sectional view illustrating a chip capacitor mounted on a PCB according to the invention.

### DETAILED DESCRIPTION OF THE PREFERRED EMBODIMENT

Exemplary embodiments of the present invention will now be described in detail with reference to the accompanying drawings.

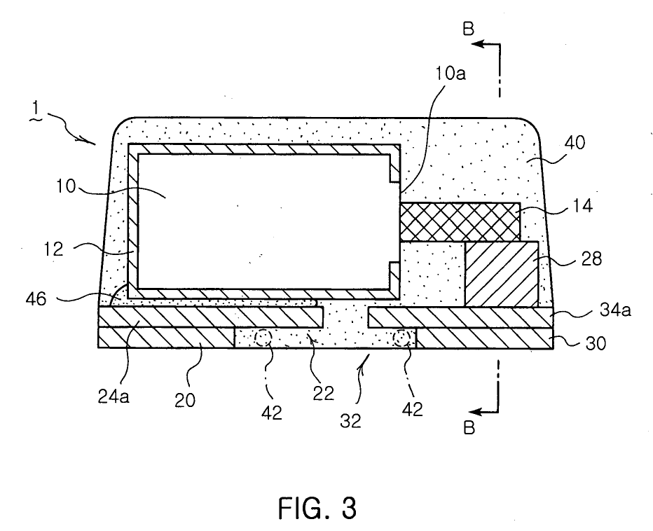

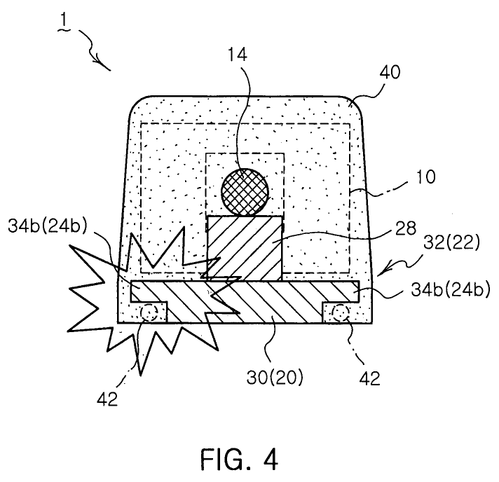

As shown in FIGS. 3 and 4, a chip capacitor 1 according to the invention includes a capacitor device 10 having a cathode layer 12 formed on an outer surface thereof and an anode wire 14 protruding from a portion thereof.

The capacitor device 10 is a dielectric device obtained by compressing a tantalum oxide (Ta₂O₅) powder into a parallelepiped shape. But the invention is not limited to tantalum Ta, and optionally, other material such as Nibio (Nb) can be employed.

The capacitor device 10 as described above is rectangular box shaped. The capacitor device 10 has a front surface 10a from a portion of which the anode wire 14 is protruded and a rear surface 10b opposing the front surface 10a.

The capacitor device 10 has a cathode layer 12 formed on an outer surface thereof and a cathode lead 20 electrically connected to the cathode layer 12.

The cathode lead 20 is connected to the cathode layer 12 through an Ag paste as in the prior art. The cathode lead 20 has a protrusion 22 protruding from an outer surface thereof, thereby forming steps on the outer surface thereof. As shown in FIG. 3, the protrusion 22 has a step 24a extended along a length direction of the cathode lead 20, i.e., in a length direction of the capacitor device 10. Also, as shown in FIG. 4, the protrusion 22 has steps 24b extended along a width direction of the cathode lead 20, i.e., in a width direction of the capacitor device 10.

Moreover, the chip capacitor 1 of the invention includes an anode lead 30 electrically connected to the anode wire 14 protruding from the front surface thereof through a weld reinforcement 28.

The anode lead 30 is connected to the anode wire 14 through the weld reinforcement as in the prior art, preferably by laser welding.

The anode lead 30 has a protrusion 32 protruding from an outer surface thereof, thereby forming steps on the outer surface thereof.

As shown in FIG. 3, the protrusion 32 has a step 34a extended along a length direction of the anode lead 30, i.e., in a length direction of the capacitor device 10. Also, as shown in FIG. 4, the protrusion 32 has steps 34b extended along a width direction of the anode lead 30, i.e., in a width direction of the capacitor device 10.

Meanwhile, to form a molding in the chip capacitor 1 of the invention, the capacitor device 10 is molded to expose only some portions, i.e., underside surfaces of the cathode lead 20 and the anode lead 30.

The molding 40 carries electromagnetic compatibility (EMC) characteristics. That is, with these characteristics, the molding 40 emits a minimum amount of unnecessary electromagnetic waves outside the device, thereby not interfering electromagnetically with other devices. Also, the molding 40 operates normally even under the influence of external electromagnetic interference.

As described above, the molding 40 surrounds the capacitor device 10, the cathode lead 20, the anode wire 14, the weld reinforcement 28 and the anode lead 30, only exposing the underside surfaces of the cathode lead 20 and the anode lead 30, respectively. This forms a lead reinforcement area 42 around the steps of the cathode lead 20 and the anode lead 30, respectively.

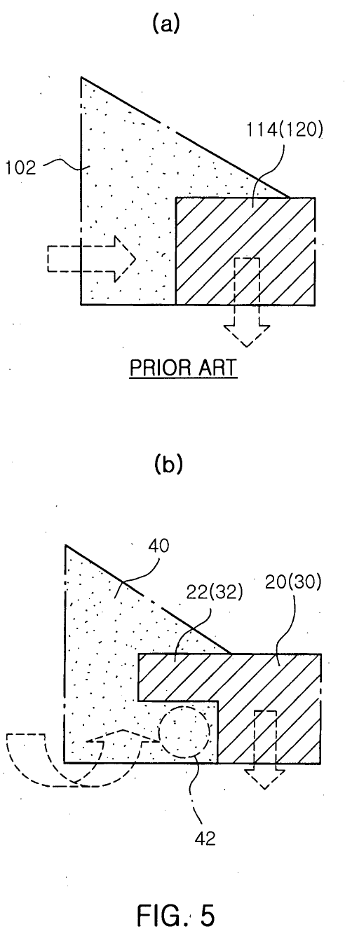

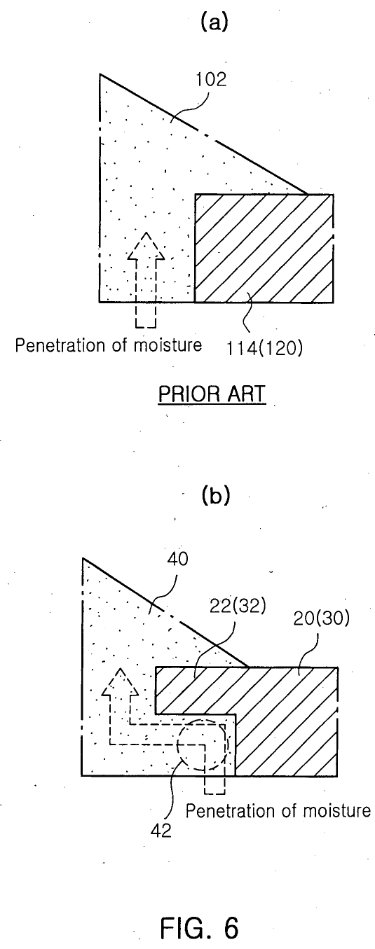

Such a lead reinforcement area 42 is depicted in FIGS. 5 and 6.

As shown in FIG. 5, the lead reinforcement area 42 serves as a stopper which effectively prevents the anode and cathode leads 20 and 30 from being detached from the molding 40.

Therefore, the anode and cathode leads 20 and 30, even if pulled down from the molding 40, are not disengaged from the molding 40 due to the lead reinforcement area 42.

Furthermore, as shown in FIG. 6, external moisture can be more effectively deterred from penetrating into the capacitor device 10 due to a longer path. This significantly boosts moisture resistance.

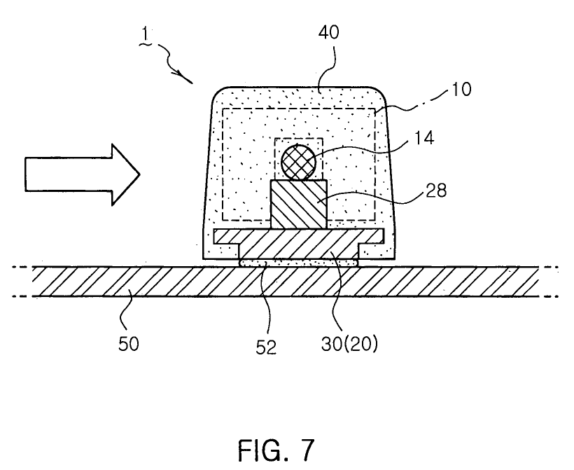

The chip capacitor 1 configured as above is mounted on a PCB 50 as shown in FIG. 7.

Here, underside surfaces of anode and cathode leads 20 and 30 are mounted on the PCB 50 by soldering 52.

When it comes to bonding strength of the chip capacitor mounted as just described, it is experimentally found that the anode and cathode leads 20 and 30 are structurally robust without being detached from the molding 40 due to the lead reinforcement area 42.

Moreover, the protrusions 22 and 32 protruding from outer surfaces of the anode and cathode leads 20 and 30 allow the leads 20 and 30 to contact the molding 40 in a larger area. This ensures stable bonding between the leads 20 and 30 and the molding and also noticeably increases moisture resistance.

In addition, the protrusions 22 and 32 protruding from the outer surfaces of the anode and cathode leads 20 and 30, especially the protrusion 22 of the cathode lead, considerably enlarges the planar area, thereby greatly increasing an area of an Ag paste layer 46 which is bonded to the cathode layer 12 of the capacitor device 10. This assures structurally and electrically stable bonding.

As described above, when the Ag paste layer 46 is increased in its bonding area due to the protrusion 22 of the cathode lead 20, the capacitor device 10 can be securely mounted on the PCB. Especially, the Ag paste layer 46 is remarkably increased in its bonding area, thereby enhancing conduction between the capacitor device 10 and the cathode lead 20. In consequence, this greatly boosts impendence or equivalent series resistance (ESR) characteristics of the chip capacitor 1.

As set forth above, according to exemplary embodiments of the invention, steps are formed on outer surfaces of anode and cathode leads along length and width directions. These steps form a lead reinforcement area, thereby significantly enhancing bonding strength between a molding and the leads and ensuring structural stability.

Also, the steps allow the anode and cathode leads to contact the molding in a larger area. Thus, external moisture can be deterred from infiltrating into the capacitor device, thereby greatly improving moisture resistance.

In addition, the chip capacitor of the invention is compact, slim and highly reliable and is structurally and electrically stable when mounted on a PCB.

While the present invention has been shown and described in connection with the preferred embodiments, it will be apparent to those skilled in the art that modifications and variations can be made without departing from the spirit and scope of the invention as defined by the appended claims.

What is claimed is:

1. A chip capacitor comprising:
a capacitor device having a cathode layer formed on an outer surface thereof and an anode wire protruding from a portion thereof;
a cathode lead electrically connected to the cathode layer;
an anode lead electrically connected to the anode wire through a weld reinforcement;
a molding configured to cover the capacitor device in such a way that the cathode and anode leads are only partially exposed; and
protrusions protruding from outer surfaces of the cathode and anode leads, respectively, thereby forming steps on the outer surfaces thereof,
whereby the chip capacitor is enabled to have a miniaturized structure with structural stability.

2. The chip capacitor according to claim 1, wherein the steps of the protrusions are extended along length and width directions of the cathode lead.

3. The chip capacitor according to claim 1, wherein the steps of the protrusions are extended along length and width directions of the anode lead.
